(19) United States
(12) Patent Application Publication
(10) Pub. No.: US 2019/0197268 A1
(43) Pub. Date: Jun. 27, 2019

(54) BAG TRACKING SYSTEMS AND METHODS

(71) Applicants: Aldemar Moreno, Houston, TX (US); Francisco J. Garcia, Kerrville, TX (US)

(72) Inventors: Aldemar Moreno, Houston, TX (US); Francisco J. Garcia, Kerrville, TX (US)

(21) Appl. No.: 15/852,092

(22) Filed: Dec. 22, 2017

(51) Int. Cl. G06K 7/10; B64F 1/36

(52) U.S. Cl. CPC G06K 7/10366; B64F 1/368; G06K 7/10297

(57) ABSTRACT

A method of tracking bags including associating a bag with a customer, scanning the bag at a drop off location, scanning the bag at a sorting station, scanning the bag at a gate, and scanning the bag at an airplane. Also, a system for tracking bags including a bag having a tracking element, a tracking element reader disposed at a drop off location, a second tracking element reader disposed at a sorting station, a third tracking element reader disposed at a gate, and a fourth tracking element reader disposed at an airplane. The bag is scanned at the drop off location, the sorting station, the gate, and the airplane and the tracking element is configured to provide bag information and the tracking element reader is configured to provide location information and time information at each of the drop off location, the sorting station, the gate, and the airplane for the bag.

### BACKGROUND OF THE INVENTION

Airlines and other transportation services often allow passengers to check bags prior to boarding an airplane or other transportation device. The checked bags typically are sent through various locations within an airport or other transportation hub, and as such, there are various locations at which the bags may be misdirected. Misdirected bags that are checked through transportation services often cause delays for passengers, disrupt the transportation services, decrease customer satisfaction, and ultimately result in airlines and other transportation providers losing significant monetary value.

Bags that are checked into a transportation service for handling may be misdirected in various ways. For example, bags may be scanned at a drop off location and then sent to a sorting location. At the sorting location the bags may be scanned again. If the second scan is incorrect, the bags may be directed to a wrong location, thereby providing a first opportunity for the bag to be misdirected. If the bag is directed at the sorting location to a correct gate, in the instance of an airport, the bag may be scanned a third time. However, the scan at the gate may be tied to a scanning device that is keyed to a loader or other non-static scanning location, such as the gate itself. If the bag is scanned with an incorrect location at the gate, the bag may be misdirected to an incorrect final location, or may otherwise be sorted incorrectly at a final destination. In either instance, the bag may not arrive at the correct location as a result of a scan at a gate. In still another situation, a bag may be correctly scanned at a drop off location, at a sorting location, and at a gate, but may be incorrectly scanned at an airplane or other transportation device. Thus, the bag may be incorrected associated with the airplane or other transportation device and the bag may be incorrectly sorted at a final destination or may otherwise be sent to a wrong location, such as in a condition where the airplane makes multiple stops.

In still other situations, the scanning of bags may be misdirected as a result of human error. For example, a scanning device may be used by an individual that requires the individual to calibrate or otherwise sync the scanning device with a physical location within an airport or other transportation location. In one instance, an individual may forget to calibrate or sync the scanning device to the location in which the scan occurs. As such, when a bag is scanned at a specified location the bag will actually be associated with a different location. By associating the bag with the wrong location, the bag may be misdirected or may be delayed in reaching its final destination.

Conventional systems and methods of tracking bags in an airport or other transportation location relies on numerous scans by individuals and introduces multiple variables that decrease the effectiveness of the tracking. Examples of variables that may negatively affect the tracking of bags include, human error, scanning device error, location error, tagging error, etc. As such, bags are not connected with customers, thereby allowing the bags to be misdirected or otherwise delayed or lost.

### BRIEF SUMMARY OF THE INVENTION

According to one aspect of one or more embodiments of the present invention, a method of tracking bags including associating a bag with a customer, scanning the bag at a drop off location, scanning the bag at a sorting station, scanning the bag at a gate, and scanning the bag at an airplane.

According to one aspect of one or more embodiments of the present invention, a system for tracking bags includes a bag having a tracking element, a tracking element reader disposed at a drop off location, a second tracking element reader disposed at a sorting station, a third tracking element reader disposed at a gate, and a fourth tracking element reader disposed at an airplane. The bag is scanned at the drop off location, the sorting station, the gate, and the airplane and the tracking element is configured to provide bag information and the tracking element reader is configured to provide location information and time information at each of the drop off location, the sorting station, the gate, and the airplane for the bag.

Other aspects of the present invention will be apparent from the following description and claims.

### BRIEF DESCRIPTION OF THE DRAWINGS

FIG. 1 shows a flow chart of a process for tracking bags according to embodiments of the present invention.

FIG. 2 shows a schematic representation of a system for tracking bags according to embodiments of the present invention.

FIG. 3 shows a schematic system overview in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

In embodiments of the present disclosure, bag tracking methods and systems for improving bag tracking at airports or other transportation facilities are disclosed. By improving the tracking methodology of bags at airports and other transportation facilities, the efficiency of certain aspects of transportation may be increased. Additionally, by decreasing human error in bag movement through transportation facilities, less bags may be misdirected.

Embodiments of the present disclosure provide for the use of global positioning systems and system points within a facility to track the movement of bags within the facility. Such embodiments may further associate bags with customers, thereby enabling users to prevent bags from being lost or otherwise misdirected within the facility. Furthermore, the use of global positioning systems may alert users when a bag is not in a correct location or is in a location that is different from the associated customer, thereby preventing the bag from becoming disassociated with the customer. Moreover, the global positioning system tracking methods and systems disclosed herein may further provide transportation facilities with data that allows the facilities to provide more efficient handling of bags within the facilities.

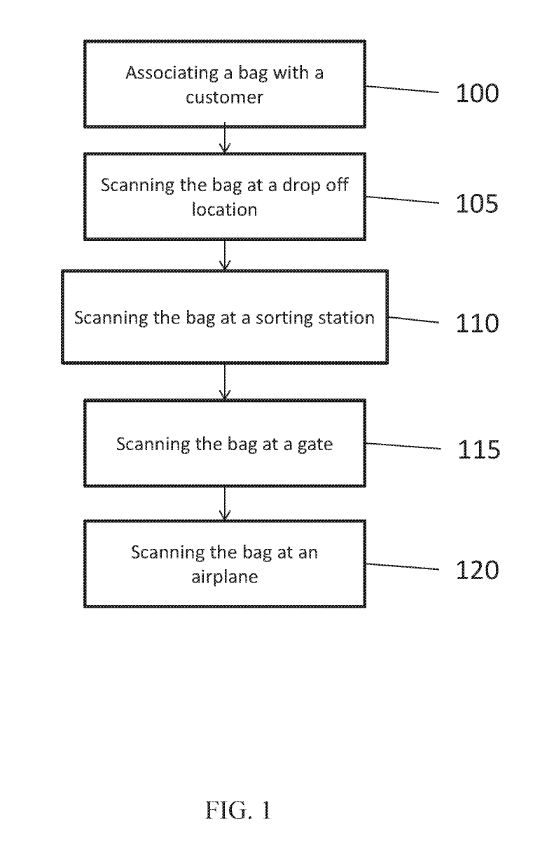

Referring to FIG. 1, a flow chart of a method of tracking bags according to embodiments of the present invention is shown. In this embodiment, the method of tracking bags initially may include associating a bag with a customer (100). The associating a bag with a customer (100) may include checking in a customer at a kiosk or other check in location. At an airport, the customer may manually check in at a kiosk that has a person handling the check in procedure. In other aspects of the present disclosure an automated kiosk may allow a customer to check in without interaction with a person.

In order to associate the bag with the customer (100), a label may be printed and attached to the bag. The label may include various information including customer information, destination information, time information, contents information, origination information, and the like. The label may include such information in written form, such as symbology that is readily interpretable by a person, may include the information as symbology that is interpretable by a scanning device, such as through barcodes, or may include combinations thereof. For example, in one embodiment, the origination information, destination information, and customer information may be printed on a label, while content information, time information, and/or other information may be printed as a barcode. Those of ordinary skill in the art will appreciate that the above description of the label that may be used to associate the bag with the customer (100) are examples and are not intended as a limitation to the breadth of information that may be used to associate the bag with the customer (100).

In certain embodiments, associating the bag with the customer (100) may further include use of tracking devices. Examples of tracking devices may include radio frequency identification tags, near field communication tags, and/or other tracking devices that communicate information automatically by passing the tracking device into proximity with a sensing device. Such devices generally may use electromagnetic fields to automatically identify and track tags attached to the bag. The tracking devices may contain electronically stored information and may be powered locally, such as in an active tracking device, or may passively receive energy from an associated radio frequency identification reader. Tracking devices may also be individually attached to bags separately from a label, as discussed above, or may be associated directly with a label such that the tracking device is embedded or otherwise disposed on or attached to a label. In certain embodiments, the tracking device may include all of the information as the label and thus no label may be attached to a bag. In such an embodiment, the tracking device would contain all the information necessary to associate the bag with the customer (100), thereby removing the need for both labels and tracking devices.

In certain embodiments the tracking device may be capable of automatically transferring information, such as time and location information to a tracking device reader. As such, rather than require a manual process of scanning a label or manually operating a tracking device reader, the tracking device may passively provide information about the bag to one or more tracking device readers disposed at various locations in an airport or other transportation facility.

Associating the bag with the customer (100) may further include the association of multiple bags with a single customer. In such a situation, a customer may be traveling with two or more bags. In this situation, a label, tracking device, or both may be disposed on each bag, thereby allowing all of the bags a customer is traveling with to be uniquely identified and individually tracked. While each bag may be individually tracked, the bags may also be associated with each other. As such, should the bags end up in different locations, a user may be notified that one or more of the bags may be misplaced or in condition to be misplaced, thereby allowing whichever bag was misplaced or in condition to be misplaced to be corrected. Similarly, multiple customers may be traveling together each with a bag or multiple bags. In such a situation, the bags of multiple customers may be linked, thereby associating multiple customers with one or more bags. As such, should one customer's bag become misplaced with respect to another customer in the same party's bag, a user may be identified thereby allowing the misplaced bag to be reassociated with the customer or the customer grouping. By allowing the grouping of customers, multiple levels of associating bags with customer(s) (100) may be created, thereby resulting in a redundancy check to prevent bags from being misplaced, lost, or otherwise not reaching a desired final destination.

After the bag is associated with the customer, the bag is scanned at a drop off location (105). In one embodiment, the customer may drop the bag off at a person operated kiosk, such as those generally found at airports or other transportation facilities where customers check in and/or drop off bags. In other embodiments, the customer may place the label or tracking device on their own bags and the bags may be scanned at the self-serve terminal.

Scanning, as used herein, does not necessarily refer to a user or operator manually scanning the bag. In one embodiment, a user or operator may manually scan the tag or activate a tracking device reader, thereby accessing information about the bag and associating the bag with a location. In other embodiments, the bag may be passively scanned as it moves throughout the transportation facility. In such a situation, the bag may be scanned by a passive tracking device reader processing data that includes time and location information. The time and location information may then be associated with the bag, thereby allowing the user or a computer system to determine the location of a specific bag at a given time.

In this step, scanning the bag at the drop off location (105) provides initial time and location for the bag within the airport or transportation facility. This initial time and location information may thereafter be used to backtrack the location of the bag at the airport or transportation facility should the bag not arrive at the next location within the desired or anticipated time. Furthermore, by associating the bag with the customer, the location and time information of the bag may be used to prevent the customer from leaving the airport prior to the bag arriving at a desired location, such as to the airplane.

In one example, the bag is scanned at the drop of location (105). The customer then proceeds through the airport eventually boarding onto a place. At this point a centralized computing system has information about the bag and the location of the customer. If the bag is not in the same location, or is not scheduled to arrive to the same location as the customer, a warning can be issued, indicating that the bag and the customer to which the bag is associated are not scheduled to arrive or depart from the same location. In a typical situation, there would be no way of tracking or otherwise determining whether the bag and the customer are scheduled to arrive or depart to the same location. As such, by associating the bag with the customer (100) and scanning the bag at the drop off location (105), the relative positions of the bag with respect to the customer may be monitored.

In addition to monitoring the relative locations of the bag and the customer, the scanned location of the bag may be used to backtrack the location of a misplaced bag. For example, if a bag is scheduled to arrive at a certain point at an airport at a certain time, and the bag does not arrive as scheduled, an operator may backtrack the location of the bag to find out where the bag is currently located. In such a situation, if the bag was checked in at the drop off location, but never makes it to a sorting station, a gate, or onto an airplane, based on the scan data, an operator may know where in the process the bag is misplaced. Additionally, because the scan may provide time and location information, the operator may more easily backtrack the location of the bag within the process, thereby speeding the processing of what might otherwise become misplaced or lost bags.

After the bag is scanned at a drop of location (105), the bag continues within the airport or transportation facility until the bag is scanned at a sorting location (110). At the sorting station, the bag is scanned again, thereby providing time and location information representative of when the bag arrived at the sorting station. As described above, scanning may include both active and passive scanning, such that an operator may manually scan a label or a tracking device, or the bag may be passively scanned by a tracking device reader.

In certain embodiments, the tracking device reader may be statically associated with the sorting location. In such a situation, the tracking device reader location does not change, and is thus static with respect to the sorting process. In other situations, the tracking device reader may be dynamic. Dynamic linkage of a scanning device or tracking device reader may allow a user or a computer system to dynamically change the association of the scanning device or tracking device reader between multiple locations. As such, the scanning device or tracking device reader may be mobile, thereby allowing flexibility in the location of the devices. While dynamic scanning and tracking device readers may increase the flexibility of usage of the devices, in certain circumstances they may introduce a potential for error. In a static-based system, a location is associated with a scanning or tracking device and the device does not move. As such, when a bag is scanned or otherwise tracked through such a static location, there is minimal risk that incorrect time and/or location information for that bag at that location will be recorded. By using static-based scanning and tracking devices, a bag that may otherwise become misplaced may be avoided because the physical location of a bag that has been statically scanned or tracked is recorded. Furthermore, because the devices may be static, backtracking a package that did not arrive at a desired or specified location may more easily be located because there is reduced chance of human error through the use of dynamic scanning or tracking devices.

In certain embodiments, the bag may be scanned multiple times at a sorting station. As such, the bag may be scanned at each juncture, to prevent the bag from being sent to an incorrect location. If a bag is tracked through an incorrect location, a user or computing system may be notified that the bag is not in the expected location, thereby allowing a potentially misplaced or lost bag to be found and the location corrected.

After the bag is scanned at the sorting station (110), the bag continues through the airport or transportation facility until it reaches a gate. Once the bag arrives at the gate, the bag may be scanned at the gate (115). As described above, the scanning or tracking of the bag at the gate (115) may be active or passive and may involve human interaction or may be computer controlled by passing the bag over or proximate a tracking device reader.

In conventional bag tracking systems, rather than associate a scan of a bag with a gate, the scan of the bag is associated with a loading device. The loading device may be moved between multiple gates at an airport and is thus representative of a dynamic type of scan or track. Because the loading device is not static within the airport, a user must manually provide the location of the loader, thereby introducing a potential for error because if the user does not correctly associate the loading device with the gate, the bag will be scanned as if it was at an incorrect gate, even if the loading device was in the correct location.

After the bag is scanned at the gate (115), the bag may be loaded onto an airplane or other type of transportation. As the bag is loaded on to the airplane, the bag is scanned (120) to indicate that the bag is in the process of being loaded onto the airplane. As described above, the scanning or tracking of the bag at the airplane (120) may be active or passive and may involve human interaction or may be computer controlled by passing the bag over or proximate a tracking device reader.

As the bag is now loaded on or in the process of being loaded on the airplane, a computer system can provide a check to verify that the bag and the customer associated with the bag are at the same location. If the locations do not match, or if the bag scans into the wrong location, the computer system may notify a user that an error has occurred and that a bag has been or is in the process of being misplaced. Because the bag is scanned or otherwise tracked onto the airplane, an incorrect location of a bag may be determined, thereby providing a final check to prevent bags from being loaded onto the wrong airplane.

Additionally, if the bag is not scanned onto the airplane (120) within a specified or anticipated time, the computer system may verify a user that the bag did not arrive at the expected location. A user may then backtrack the bag to the scan at the gate (115) or to a prior location to determine the location of the bag and prevent the bag from being misplaced or lost.

In certain embodiments, the drop off location, the sorting station, the gate, and/or the airplane may include a global positioning system point, thereby allowing location information to be determined or verified at each point the bag may travel. In certain embodiments, a global positioning system point may be generated at each of the locations the bag travels, while in other embodiments, one, two, three, or more locations may have global positioning system points associated therewith. A global positioning system is generally a space-based radio navigation system that provides geolocation and time information. The geolocation and time information may be provided to a global positioning system receiver located virtually anywhere on Earth where there is an unobstructed line of sight to four or more global positioning satellites.

Global positioning system points may be established at various locations within a transportation facility. Because a transportation facility may include multiple global positioning points at various locations such as, for example, the drop off location, the sorting station, the gate, and/or the airplane, a bag and/or a customer associated with a bag may be tracked during their respective movements within the transportation facility. For example, because a bag may be associated with a first global positioning system point, such as a drop off location, and later be associated with a second location, for example, the sorting station, and finally a third global positioning system point, for example, a gate, the movement of the bag throughout the facility may be monitored. In addition to knowing the relative position of the bag within the facility based on the global positioning system point scans, should a bag be anticipated to arrive at a certain location at a certain time, if the bag is not scanned in at the appropriate global positioning system point at the time, an exception may be noted and a user identified that a bag may be in an incorrect location.

Additionally, the global positioning system points may be used to identify a relative location of a bag within a facility. For example, if a bag is properly scanned into a first, second, and third global positioning point, but is not scanned into a fourth point, a user may use the data to determine that the bag is located between the third and fourth point. Because the user knows generally where the bag is located within the facility, recovery of the bag may be expedited, thereby saving time and resources in locating a misplaced bag.

Furthermore, using global positioning system points may allow bags to be more accurately associated with customers. For example, if a customer and a bag are associated and the customer is located at a final destination point, such as an airplane, but the bag associated with the customer is not located at the final destination point, an exception may occur, thereby notifying a user that the bag and customer are not located at the same location. Furthermore, if the customer and the associated bag are located at different locations, a user may be notified that either the customer or the bag is at the incorrect location, thereby allowing the user to rectify the incorrect location and reassociate the bag and the customer.

In certain embodiments, using global positioning system points to track and otherwise monitor the movement of bags within a facility may also allow for process flow metrics to be identified. By tracking the time it takes for bags to move within a facility, users may identify methods to streamline the movement of the bags, thereby making the flow within the facility operate more efficiently.

Global positioning systems also allow for the system to be changed to further enhance the tracking of customers and associated bags. For example, global positioning systems do not require static points to be established. As such, users may scan a bag at any point in the facility to determine whether the bag is in the correct location at the correct time. Because global positioning systems allow for the dynamic tracking of bags, if a bottleneck is established within a facility additional global positioning system points may be established to enhance the tracking of the bags.

In certain situations, one or more of the locations the bag passes through may not be capable of using global positioning system points due to the location being underground or within insufficient line of sight to the required satellites. In such situations, static points may be used instead of the global positioning system. Static points refer to locations of scanning or tracking device readers that remain constant. Such points may be identified by unique location identifiers or may be identified by common coordinate locators, latitude and longitude, addresses, or any other location identifiers known to those of skill in the art.

While certain locations may not be capable of receiving traditional global positioning signals because of the lack of line of sight, non-line of sight global positioning systems may be used to overcome the line of sight deficiency. For example, in a covered or underground system a global positioning system receiver may not be capable of receiving normal satellite signals due to the lack of line of sight. However, the global positioning system may be capable of receiving signals from other global positioning systems located within the facility. The signals may be provided from the line of sight global positioning systems to the non-line of sight global positioning systems, thereby providing location information to the non-line of sight global positioning system receivers. The non-line of sight global positioning system receivers may also be able to receive signals from satellites or other locations not associated with the facility. Such non-line of sight signals may be resolved to create “ghost satellites” that may allow non-line of sight global positioning system receivers to resolve the ghost satellite data into location data at the facility. Such ghost satellites may be used in, for example, our door areas that are shielded from receiving line of sight signals, but still can receive signals from other satellites or locations to which the global positioning system receivers have line of sight.

Those of ordinary skill in the art will appreciate that in certain facilities global positioning, whether static or dynamic, may be used in combination with static points and/or non-line of sight global positioning system points to allow users to track bags and/or customer movement within the facility. Such global positioning systems may be used to create any number of check points within the facility and may further be used to monitor the movement of bags, associate bags with locations, associate bags with customers, or monitor the flow of bags and/or customers within the facility to improve facility efficiency.

At each location the bag moves through the scanning or tracking may include recording a time stamp. The time stamp may be used to determine when a bag arrived at a location, when a bag was present at each location, when a bag left a location, how long a bag remained at a location, and the like. Similarly, the time stamp may be used during backtracking to more quickly locate a bag that did not arrive at an anticipated location by an anticipated time.

In certain embodiments, a computer system may be used to determine a time interval the bag is scheduled to arrive or leave a certain location. As such, if a bag does not arrive according to schedule or does not leave according to schedule, the computer system may alert a user that there is the potential for a misplaced bag. The user may then take action or prevent the bag from being misplaced.

In certain embodiments a user may have a scanning device, whether passive or active, on their person for scanning or tracking bags. In such a circumstance, the scanning device or tracking device reader may be used to track or verify the location of the operator. As such, a computer system may determine if an operator is in the correct location and prevent bags from being misplaced based on the relative location of the operator to either a specified anticipated location or other metrics as would be known to those of ordinary skill in the art.

As discussed above, the scanning or tracking may be active or passive. As such, automated scanning or tracking may thereby allow a bag to move between various locations at an airport or other transportation facility and be scanned or tracked without requiring human interaction. By decreasing the amount of human error that may be introduced into the process, there are less chances that an incorrect location will be recorded for a bag, thereby further decreasing the likelihood that a bag is misplaced or lost.

In addition to the movement of bags within an airport or transportation facility being more efficient as a result of less need for human interaction and better data on where bags are located, data may also be gathered on bag movement to further streamline the process. For example, because each bag may be tracked at various locations within the airport, anticipated time intervals it takes a bag to move between each location may be recorded and used to determine more efficient routes for moving bags. Additionally, if certain routes are routinely out of an anticipated range of acceptable movement times, the variance may be used to identify broken or inefficient equipment, process, methods, or human interaction that is causing a problem. Because the data may be passively collected, the computing system may be used to regressively analyze the movement patterns of bags within the airport to make bag movement more efficient. In such an embodiment where data is gathered and resolved by the computing system, the gathered data may include location and time information. Those of ordinary skill in the art will appreciate that other types of data may also be gathered including, for example, bag contents, weight, shape, origin, destination, and the like. Thus, the location information and time information may be resolved to determine a time a bag is at one or more, or each, of the drop off location, the bag sorting station, the gate, and the airplane.

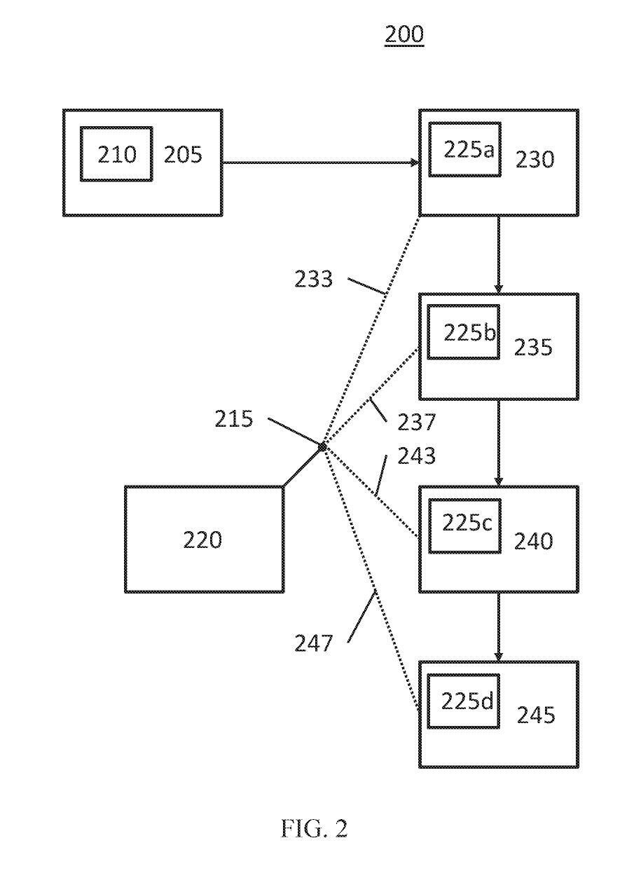

Referring to FIG. 2, a schematic of a system for tracking bags in accordance with one or more embodiments of the present invention is shown. In this embodiment, the system 200 includes a bag 205 having a tracking element 210 attached thereto. The tracking element may include an electronic tracking element or a label, as described above in FIG. 1.

The system 200 may be used at various types of transportation facilities, such as airports, train stations, bus stations, and other locations where bags are checked by customers and the customers are temporarily not in possession of the bag 205. Examples of bags 205 may include customer luggage, parcels, boxes, special equipment, animals, and any other types of baggage 205 that a customer may desire or be required to check in at a transportation facility.

The tracking element 210 may include various types of tracking devices, such as those discussed above, for example, radio frequency identification or near field communication tracking devices. The tracking element 210 may be capable of providing, either actively or passively, location and time information at various locations in the transportation facility. Additionally, tracking element 210 may provide bag information, such as customer association data, content data, and the like. For example, the tracking element 210 may contain information identifying a particular bag 205, such that as the bag 205 is scanned or tracked by scanning or tracking device readers disposed at various locations at a transportation facility, the tracking element 210 may provide information about the bag 205 that may then be resolved with the time and location of the bag 205 with respect to the scanning or tracking reader, thereby allowing a computing system to determine the location of the bag 205 at a specific time.

The system 200 may further include a wireless network 215 connected to a computing system 220 that is configured to compile the location information and the time information recorded at various locations at the transportation facility. At selected location within the transportation facility, a scanning or tracking element reader 225 may be disposed, thereby allowing information provided by the tracking element 210 to be transferred to the scanning or tracking element reader 225, such that the time and location information from the bag 205, as well as bag information, may be transferred to the computing system 220.

Global positioning systems may be used to create global positioning points within the facility. At such global positioning points, a receiver (not independently illustrated) may be used to monitor whether the bag 205 has been received and/or left the specific global positioning point. The global positioning system receivers or other components thereof may be part of scanning or tracking element reader 225. In certain embodiments, a global positioning system receiver may be directly linked to the computing system 220 via wired or wireless connection.

As described above, scanning or tracking element readers 225 that contain global positioning system receivers or components capable of resolving global positioning system signals may be disposed at various locations within a facility. Additionally, such scanning or tracking element readers 225 may be hand held devices that a user may use or place at various locations within the facility. The dynamic use of such scanning or tracking element readers 225 may thereby allowing various global positioning system points to be established within a facility. Furthermore, because the global positioning systems may be moveable within the facility, users may be capable of setting up global positioning system points that are temporary in nature.

In certain embodiments, the scanning or tracking element reader 225 may be static, such that the location of the scanning or tracking element reader 225 does not change. Examples of when static scanning or tracking element readers 225 may be beneficial is in locations that cannot be reached to determine global positioning points. Static points may be used at various locations, however, examples of typical locations may include sorting stations and gates at airports.

In order to explain an exemplary movement and tracking of the bag 205 in the system 200, such as at an airport, each step of the process is hereby described in detail below. Initially, bag 205 is associated with a customer and the association is stored as bag information on tracking element 210. Tracking element 210 is attached or otherwise disposed on or within bag 205, thereby allowing bag 205 to be tracked within the airport or other transportation facility.

When the bag 205 is associated with a customer, the customer may then drop the bag off at a drop off location 230. At the drop off location, a first tracking element reader 225a is disposed, thereby allowing the bag 205 to be tracked as it enters, passes through, or exits drop off location 230. In one embodiment, when the bag 205 is checked in, bag information is read by first tracking element reader 225a, and is associated with time and location information. The bag information, time information, and location information is then sent to computing system 220 so that the computing system 220 may resolve the information and track bag 205 as it moves within the airport or other transportation facility. In one embodiment, the bag information, time information, and location information may be consolidated into a data file and transmitted wirelessly 233 via wireless network 215 to computing system 220. In other embodiments, computing system 220 may be wired directly to first tracking element reader 225a. At this point, the information about the bag 205, including its location and time within the facility is stored in computing system 220.

After the bag 205 leaves drop off location 230, the bag 205 may be moved to a storing station 235. At the sorting station 235 the bag may be directed for transference to another location within the airport or other transportation facility. Those of ordinary skill in the art will appreciate that at this point the bag 205 may be scanned or tracked multiple times as the bag 205 may go through multiple sorting areas within sorting station 235. As bag 205 enters sorting station 235, bag 205 may be read by a second tracking element reader 225b. The bag information, time information, and location information is then sent to computing system 220 so that the computing system 220 may resolve the information and track bag 205 as it moves within the airport or other transportation facility. In one embodiment, the bag information, time information, and location information may be consolidated into a data file and transmitted wirelessly 237 via wireless network 215 to computing system 220. In other embodiments, computing system 220 may be wired directly to second tracking element reader 225b. At this point, the information about the bag 205, including its location and time within the facility is stored in computing system 220.

In certain embodiments, computing system 220 may gather data about the bag 205 or multiple bags in order to determine whether the bag 205 arrived in accordance with a desired schedule. If the bag 205 did not arrive at the expected time, an alert may be triggered so that a user knows that the bag was late in arriving to sorting station 235. In still other embodiments, bag 205 may not have arrived at sorting station 235 during the required time frame. In such a situation, computing system 220 may alert a user that the bag 205 may be misdirected. Accordingly, the user may backtrack the bag 205 to a location between sorting station 235 and drop off location 230, in order to resolve the issue and put bag 205 back into movement according to schedule.

Data gathered about the movement of bag 205 within the airport may also be used to determine whether there are malfunctions in the movement system of the airport or other transportation facility. If multiple bags 205 are routinely not moved according to schedule, computing system 220 may alert a user that there is a malfunction in the movement of bags 205 between one or more places within the airport or other transportation facility. As described above, the data gathered by computing system 220 may be used to identify malfunctioning equipment, identify inefficiencies, and promote more efficient movement of bags 205 within the facility.

After the bag 205 is correctly sorted at sorting station 235, bag 205 may be directed to a gate 240. As bag 205 enters gate 240, bag 205 may be read by a third tracking element reader 225c. The bag information, time information, and location information is then sent to computing system 220 so that the computing system 220 may resolve the information and track bag 205 as it moves within the airport or other transportation facility. In one embodiment, the bag information, time information, and location information may be consolidated into a data file and transmitted wirelessly 243 via wireless network 215 to computing system 220. In other embodiments, computing system 220 may be wired directly to third tracking element reader 225c. At this point, the information about the bag 205, including its location and time within the facility is stored in computing system 220.

As described above, gate 240 may provide a location where bags 205 are routinely misplaced or otherwise misdirected. Because equipment, such as loading devices, may be shared between multiple gates 240, there is the potential for human error to cause the bag 205 to be misdirected or otherwise provide inaccurate information about the location of bag 205 within the airport or other transportation facility. In order to prevent or at least minimize such errors, gate 240 may include a static third tracking element reader 225c, that is not attached to equipment, such as loading devices, but is associated with the gate 240. As such, when bag 205 enters gate 240, the information about the bag, including bag information, time information, and location information, is associated with the location of the bag 205 at gate 240 rather than between bag 205 and a specific piece of equipment, such as a loading device.

When bag 205 is ready to be put onto an airplane 245, the bag 205 may be loaded onto the airplane 245 for transport to its final destination. As bag 205 enters airplane 245, bag 205 may be read by a fourth tracking element reader 225d. The bag information, time information, and location information is then sent to computing system 220 so that the computing system 220 may resolve the information and track bag 205 as it moves within the airport or other transportation facility. In one embodiment, the bag information, time information, and location information may be consolidated into a data file and transmitted wirelessly 247 via wireless network 215 to computing system 220. In other embodiments, computing system 220 may be wired directly to fourth tracking element reader 225d. At this point, the information about the bag 205, including its location and time within the facility is stored in computing system 220.

At this point, computing system 220 may resolve the bag information, time information, and location information, and reassociate the bag 205 with the customer to make sure that the bag 205 and the customer are both in the correct location, namely, on airplane 245. If there is an error and the bag 205 or the customer are not on the same airplane 245, a user may be notified that there is an error. The user may then review the situation to determine if there is an error, for example, whether bag 205 or customer is in the incorrect location. The user may then take positive action to resolve the situation so that bag 205 and the customer are correctly associated.

Those of ordinary skill in the art will appreciate that the system 200 described above may be modified according to the methods described with respect to FIG. 1, above. For example, in certain embodiments first, second, third, or fourth tracking element readers 225 may be static or dynamic. Similarly, first, second, third, or fourth tracking element readers 225 may require manual input or may be automatic. Those of ordinary skill in the art will appreciate that static and automatic first, second, third, or fourth tracking element readers 225 may provide advantages of removing the potential for human error, as well as providing static points that can be resolved by computing system 220 to provide data to improve the process and system 200.

Additionally, one or more of the scanning or tracking element readers 225 may include components capable of receiving global positioning system signals. Because such scanning or tracking element readers 225 can resolve global positioning system signals, the element readers 225 may be used to create global positioning system points within a facility. Accordingly, the time and location data provided by the global positioning systems may be used to associate a bag 205 with a specific location within the facility. As discussed above, such scanning or tracking element readers 225 may be configured to use global positioning system signals to create global positioning system points, static points, or non-line of sight global positioning system points. Regardless of the type of point created by the scanning or tracing element readers, location and time information about a bag 205 may be used to track the bag 205 within the facility. Furthermore, the created points may be used to associate customers with bags as well as locations within the facility.

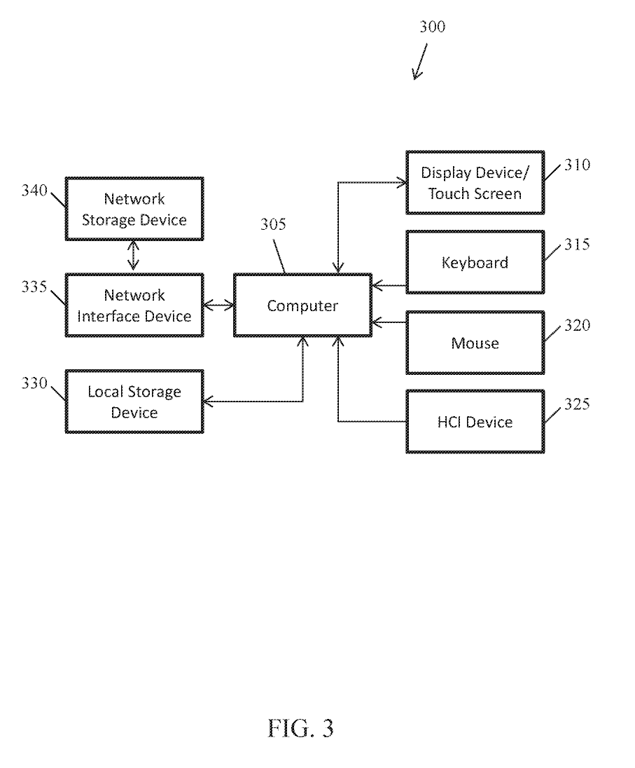

Referring to FIG. 3 a computing system 300 in accordance with one or more embodiments of the present invention is shown. Computing system 300 may include one or more computers 305 that each includes one or more printed circuit boards (not shown) or flex circuits (not shown) on which one or more processors (not shown) and system memory (not shown) may be disposed. Each of the one or more processors (not shown) may be a single-core processor (not shown) or a multi-core processor (not shown). Multi-core processors (not shown) typically include a plurality of processor cores (not shown) disposed on the same physical die or a plurality of processor cores (not shown) disposed on multiple die that are disposed in the same mechanical package. Computing system 300 may include one or more input/output devices such as, for example, a display device 310, keyboard 315, mouse 320, and/or any other human-computer interface device 325. The one or more input/output devices may be integrated into computer 305. Display device 310 may be a touch screen that includes a touch sensor (not shown) configured to sense touch. A touch screen enables a user to control various aspects of computing system 300 by touch or gestures. For example, a user may interact directly with objects depicted on display device 310 by touch or gestures that are sensed by the touch sensor and treated as input by computer 305.

Computing system 300 may include one or more local storage devices 330. Local storage device 330 may be a solid-state memory device, a solid-state memory device array, a hard disk drive, a hard disk drive array, or any other non-transitory computer readable medium. Local storage device 330 may be integrated into computer 305. Computing system 300 may include one or more network interface devices 340 that provide a network interface to computer 305. The network interface may be Ethernet, Wi-Fi, Bluetooth, WiMAX, Fibre Channel, or any other network interface suitable to facilitate networked communications. Computing system 300 may include one or more network-attached storage devices 340 in addition to, or instead of, one or more local storage devices 330. Network-attached storage device 340 may be a solid-state memory device, a solid-state memory device array, a hard disk drive, a hard disk drive array, or any other non-transitory computer readable medium. Network-attached storage device 350 may not be collocated with computer 305 and may be accessible to computer 305 via one or more network interfaces provided by one or more network interface devices 335. One of ordinary skill in the art will recognize that computer 305 may be a server, a workstation, a desktop, a laptop, a netbook, a tablet, a smartphone, a mobile device, and/or any other type of computing system in accordance with one or more embodiments of the present invention.

Scanning and tracking device readers used in accordance with embodiments of the present disclosure may operate in a variety of ways. In one embodiment, a scanning or tracking device reader may interpret data by scanning a visual representation on bags, such as a label. Examples of visual representations may include, for example, barcode based symbology. In other embodiments, a scanning or tracking device reader may interpret data through radio-frequency identification. Through the use of radio-frequency identification, radio-frequency electromagnetic fields are used to transfer data from a tracking device on a bag to the scanning device. Those of ordinary skill in the art will appreciate that in addition to barcode symbology and radio-frequency identification other types of automatic identification data capture may also be used. For example, the scanning device, may be configured to interpret magnetic stripes, optical characters, smart cards, near field communication, and the like. Thus, the scanning device may be used to obtain data from the bags, such as, for example, time and location data.

In certain embodiments, computing system 300 may be connected directly or indirectly to one or more of the scanning or tracking device readers. The connections may be wired or wireless, and may include connections with both static and dynamic device readers. As such, computing system 300 may include instructions to resolve data provided by the device readers to allow the monitoring and tracking of bags within an airport or other transportation facility. Examples of data resolving may include determination of anticipated bag locations, expected bag transfer speeds, backtracking metrics, origin or final destination information, operator location, bag and customer association, and the like. In certain embodiments computing system 300 may be used to collect data from all bags in an airport, thereby allowing an operator to know a relative location of a bag to a customer. Furthermore, the computing system 300 may be used to identify when a bag is misplaced, thereby allowing the relatively quick remediation of an issue, preventing the bag from being lost, late, or otherwise not associated with the customer.

In one or more embodiments of the present invention, the methods and systems disclosed herein for tracking bags may allow an automated process that decreases human error associated with scanning bags.

In one or more embodiments of the present invention, the method for tracking bags may allow the bags to be more efficiently transferred within a transportation facility, such as an airport, due to decreased handling and manual processes.

In one or more embodiments of the present invention, the methods and systems disclosed herein for tracking bags may allow for time and location information for each bag in a transportation facility to be tracked, thereby allowing misplaced bags to be located more efficiently.

In one or more embodiments of the present invention, the methods and systems disclosed herein for tracking bags may allow a relative location of a bag to be known by resolving time and location information between at least two places at a transportation facility.

In one or more embodiments of the present invention, the methods and systems disclosed herein for tracking bags may allow for the reverse tracking of employee routes be resolving the time and location information for tracking device readers and/or bags the employee tracked.

In one or more embodiments of the present invention, the methods and systems disclosed herein for tracking bags may allow for static points to be used at various locations within a transportation facility, thereby preventing borrowed items, such as loading devices, from recording incorrect time and location information.

In one or more embodiments of the present invention, the methods and systems disclosed herein for tracking bags may allow for more efficient backtracking of misplaced bags due to time and location information gathered on each bag at each location.

In one or more embodiments of the present invention, the methods and systems disclosed herein for tracking bags may allow for global positioning system points to be associated with bags, thereby allowing a computer system and/or operators to know the relative location of bags within a transportation facility.

In one or more embodiments of the present invention, the methods and systems disclosed herein for tracking bags may allow radio frequency identification, near field communication, and other tracking devices to be associated with bags, thereby allowing time, location, and other information about the bags to be gathered as the bags move through a transportation facility.

In one or more embodiments of the present invention, the methods and systems disclosed herein for tracking bags may allow for data to be gathered on the movement of bags through a transportation facility, thereby allowing for bottlenecks, inefficiencies, broken equipment, and other issues to be identified and resolved.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of tracking bags, the method comprising
associating a bag with a customer;
scanning the bag at a drop off location;
scanning the bag at a sorting station;
scanning the bag at a gate; and
scanning the bag at an airplane.

2. The method of claim 1, wherein the scanning includes recording a global positioning system point at the drop off location, the bag sorting station, the gate, and the airplane.

3. The method of claim 1, wherein the scanning includes recording a time stamp at the drop off location, the bag sorting station, the gate, and the airplane.

4. The method of claim 1, wherein the scanning includes recording a global positioning system point and a time stamp at the at the drop off location, the bag sorting station, the gate, and the airplane.

5. The method of claim 1, wherein the scanning comprises a static point location identifier disposed proximate at least one of the drop off location, the bag sorting station, the gate, and the airplane.

6. The method of claim 4, further comprising determining a time interval the bag is at the drop off location, the bag sorting station, the gate, and the airplane.

7. The method of claim 1, further comprising tracking an operator location based on the scanning.

8. The method of claim 1, wherein the gate comprises a static scan location.

9. The method of claim 8, wherein the sorting station comprises a second static scan location.

10. The method of claim 1, wherein the scanning comprises automated scanning.

11. The method of claim 1, further comprising gathering data on the bag.

12. The method of claim 11, wherein the gathering data further comprises location information and time information.

13. The method of claim 12, further comprising resolving the location information and the time information, and determining a time the bag is at each of the drop off location, the bag sorting station, the gate, and the airplane.

14. A system for tracking bags comprising:
a bag having a tracking element;
a tracking element reader disposed at a drop off location;
a second tracking element reader disposed at a sorting station;
a third tracking element reader disposed at a gate; and
a fourth tracking element reader disposed at an airplane,
wherein the bag is scanned at the drop off location, the sorting station, the gate, and the airplane; and
wherein the tracking element is configured to provide bag information and the tracking element reader is configured to provide location information and time information at each of the drop off location, the sorting station, the gate, and the airplane for the bag.

15. The system of claim 14, wherein the tracking element comprises a radio frequency identification tag.

16. The system of claim 14, wherein the tracking element comprises a near field communication tag.

17. The system of claim 14, further comprising a wireless network connected to a computing system, wherein the computing system is configured to compile the location information and time information recorded at the drop off location, the sorting station, the gate, and the airplane for the bag.

18. The system of claim 14, wherein the tracking element reader is configured to automatically provide the location information and the time location at each of the drop off location, the sorting station, the gate, and the airplane for the bag.

19. The system of claim 14, wherein the third tracking element reader comprises a static point.

20. The system of claim 19, wherein the second tracking element reader comprises a static point.
